(19) United States
(12) Patent Application Publication
(10) Pub. No.: US 2004/0003531 A1
(43) Pub. Date: Jan. 8, 2004

(54) Nozzle and method for injecting fish attractant paste into soft plastic fishing lures

(76) Inventor: Randy J. Hulin, Pineville, LA (US)

Correspondence Address: John M. Harrison, 2139 E. Bert Kouns, Shreveport, LA, 71105, US

(21) Appl. No.: 10/460,095

(22) Filed: Jun. 12, 2003

Related U.S. Application Data
(60) Provisional application No. 60/394,078, filed on Jul. 8, 2002.

(51) Int. Cl. A01K 69/00; A01K 71/00; A01K 73/00

(52) U.S. Cl. 43/4.5

(57) ABSTRACT

A nozzle characterized by a nozzle cylinder fitted with internal threads, having a cylinder flange at one end and a spout at the other end, and adapted to receive a plunger which is externally threaded, for insertion inside the nozzle cylinder and contacting a fish-attractant paste located inside the nozzle cylinder, between the plunger and the spout. Threadably rotating the plunger inside the nozzle advances the plunger against the paste and dispenses the paste through the spout and typically, into the cavity of a tubular soft plastic fishing lure. In a preferred embodiment an O-ring is provided on the plunger forwardly of the threads, which O-ring fits tightly against the smooth inside cylindrical surface of the nozzle cylinder to facilitate a seal between the plunger and the nozzle cylinder and prevent the fish attractant paste from being forced rearwardly to the threads when the plunger is threadably advanced in the nozzle. The nozzle, plunger and spout may be constructed of substantially any size in order to accommodate fish attractant paste, pellets or live bait of varying viscosity and dispense the fish attractant into tubular and other soft plastic fishing lures of various size and design.

### CROSS-REFERENCE TO RELATED APPLICATIONS

This invention claims the benefit of and incorporates by reference prior filed U.S. Provisional Application Serial No. 60/394,078, filed Jul. 8, 2002.

### BACKGROUND OF THE INVENTION

### Field of the Invention

This invention relates to plastic fishing lures and more particularly, to a nozzle for injecting a viscous fish attractant into tubular and non-tubular soft plastic fishing lures, which nozzle is typically constructed of an acrylic plastic and includes a nozzle cylinder or tube having a spout, and a nozzle plunger for insertion in the nozzle cylinder, with cooperating threads provided on the plunger and cylinder for threadably dispensing the fish attractant from the nozzle cylinder, through the spout and into the soft plastic fishing lure in a controlled manner. An O-ring is typically provided on the plunger forwardly of the threads to seal the plunger in the smooth, cylindrical internal wall of the nozzle cylinder and prevent the fish attractant from reversing rearwardly under pressure, into the threads.

One of the problems realized in injecting fish attractant such as liquid, paste, pellets, live bait and other material into tubular soft plastic fishing lures to enhance the attraction efficiency of the lures, is that of efficiently forcing significant quantities of the high viscosity fish attractant into the lure cavity in a controlled manner. High viscosity fish attractant paste and pellets such as Berkeley's “Power Bait” and similar fish attractant paste and pellet materials of high viscosity, including live bait such as shrimp, cannot be injected into tubular-type and non-tubular soft plastic fishing lures using conventional plunger-cylinder syringe-type injecting devices, since these high viscosity fish attractants are much too viscous to respond to syringe injection and are therefore difficult to insert in the soft plastic fishing lures, except manually, in tubular-type plastic lures, by means of pellets or the like. A disadvantage of inserting pellets or discrete particles of fish-attractant into the tubular-type soft plastic fishing lures is the necessity of laboriously inserting the pellets one-by-one into the opening in the tubular fishing lure, which opening tends to tear and rip when stressed, particularly when the lure is placed on a hook after loading and retrieved through a waterbody, thereby greatly decreasing the time of use and efficiency of the lure. Accordingly, it has surprisingly been found that a great advantage is realized in fishing soft plastic, tubular-type and non-tubular fishing lures by providing a nozzle and technique of inserting viscous fish attractant paste, pellets and the like, as well as live bait, into such a fishing lure in a carefully controlled manner, without substantial labor and unduly distorting or tearing the soft plastic in the injection process.

It is therefore an object of this invention to provide a nozzle device which is threaded to facilitate the injection of paste, pellets and like fish attractant materials, as well as live bait, of varying viscosity, into both tubular and non-tubular soft plastic fishing lures in a short time without damaging the structure of the lures.

Another object of the invention is to provide a new and improved nozzle having a nozzle cylinder fitted with internal threads and a plunger fitted with external threads for engaging the internal threads of the nozzle to facilitate rotation of the plunger with respect to the nozzle and forcing high viscosity fish attractant paste, pellets or the like, including live bait such as shrimp, through a spout on the nozzle and into a soft plastic, tubular-type fishing lure in a controlled manner without damaging the lure and compromising the time of use and efficiency of the lure when it is impaled on a hook and retrieval through a waterbody.

Still another object of this invention is to provide a nozzle for injecting viscous fish attractant paste and pellets and live bait into non-tubular soft plastic fishing lures in a controlled operation, which the nozzle includes a tubular housing fitted with internal threads and a flange and having a spout on the opposite end of the housing from the flange and an externally-threaded plunger threadably seated in the housing and fitted with an O-ring to facilitate careful and controlled forcing of the viscous fish attractant paste, pellets, live bait or the like from the housing, through the spout and into a soft plastic fishing lure through the small spout opening in the soft plastic fishing lure, by rotation of the plunger with respect to the housing as the spout is withdrawn in the spout opening, to enhance the attractiveness of the fishing lure to the fish and maintain the integrity of the soft plastic fishing lure for retrieval through a waterbody.

Yet another object of this invention is to provide a method for inserting a fish attractant material into soft plastic, tubular and non-tubular fishing lures without significantly damaging the soft plastic structure, which method includes the steps of providing an internally-threaded tubular nozzle housing having a spout for engaging the soft plastic fishing lures, loading a quantity of fish attractant material in the nozzle housing; inserting a threaded plunger into the nozzle housing to facilitate threadable rotation of the plunger with respect to the housing; and carefully rotating the plunger to advance the plunger in the nozzle housing at a selected flow rate and force the viscous fish attractant material from the nozzle housing, through the spout and into the soft plastic fishing lure without significantly deforming or damaging the lure.

Another object of this invention is to provide a method of quickly and easily inserting a fish attractant material, including live bait, into both tubular-type and solid soft plastic fishing lures without significantly damaging the lures, which method includes the steps of providing a cylindrical housing having a smooth inside surface with internal threads and a spout at one end for insertion in a soft plastic fishing lure; placing a fish attractant paste or composition in the housing; inserting an externally-threaded plunger fitted with an O-ring into the housing for threadably engaging the internal threads in the tubular housing; inserting the spout into the soft plastic fishing lure and carefully rotating the preferably knurled tubular plunger with respect to the tubular housing to slowly advance the plunger against the paste in the housing and force the paste at a desired rate from the tubular housing through the spout and into the soft plastic fishing lure, as the spout is withdrawn from the lure.

### SUMMARY OF THE INVENTION

These and other objects of the invention are provided in a new and improved nozzle and method for injecting live bait, as well as fish attractant paste, pellets and the like of varying viscosity into tubular and solid soft plastic fishing lures, which nozzle includes a tubular nozzle cylinder having a smooth inside surface fitted with internal threads, a flange on one end and a spout on the opposite end of the nozzle cylinder for insertion in an opening in the tubular soft plastic fishing lure, or in an opening created by the spout in the solid soft plastic fishing lure, and further including a plunger having an O-ring seal and external threads for threadably engaging the internal threads of the tubular housing, which plunger is threadably rotated in the housing to advance the plunger in the housing at a selected rate and force a quantity of typically viscous fish attractant paste or other material loaded in the nozzle cylinder, from the nozzle cylinder through the spout and into the tubular or solid soft plastic fishing lure, as the spout is slowly withdrawn from the lure, without materially damaging the plastic fishing lure.

### BRIEF DESCRIPTION OF THE DRAWINGS

The invention will be better understood by reference to the accompanying drawings, wherein:

FIG. 1 is a perspective view of the nozzle of this invention, with the nozzle spout positioned adjacent to the opening in a conventional tubular plastic fishing lure;

FIG. 2 is a perspective view of the nozzle with the spout inserted in the tubular plastic fishing lure cavity;

FIG. 3 is a sectional view taken along line 3-3 of the nozzle illustrated in FIG. 2, before the plunger is activated;

FIG. 4 is a sectional view taken along line 3-3 of the nozzle illustrated in FIG. 2, with the plunger rotated in the nozzle housing to dispense fish attractant into the tubular plastic fishing lure;

FIG. 5 is an exploded view of the plunger and nozzle housing elements of the nozzle illustrated in FIG. 1;

FIG. 6 is a perspective view, partially in section, of the nozzle of this invention, with the nozzle spout inserted in a solid soft plastic fishing lure configured as a bait fish; and

FIG. 7 is a perspective view, partially in section, of the nozzle of this invention, with the spout inserted in a solid soft plastic fishing lure configured as a worm.

### DESCRIPTION OF THE PREFERRED EMBODIMENTS

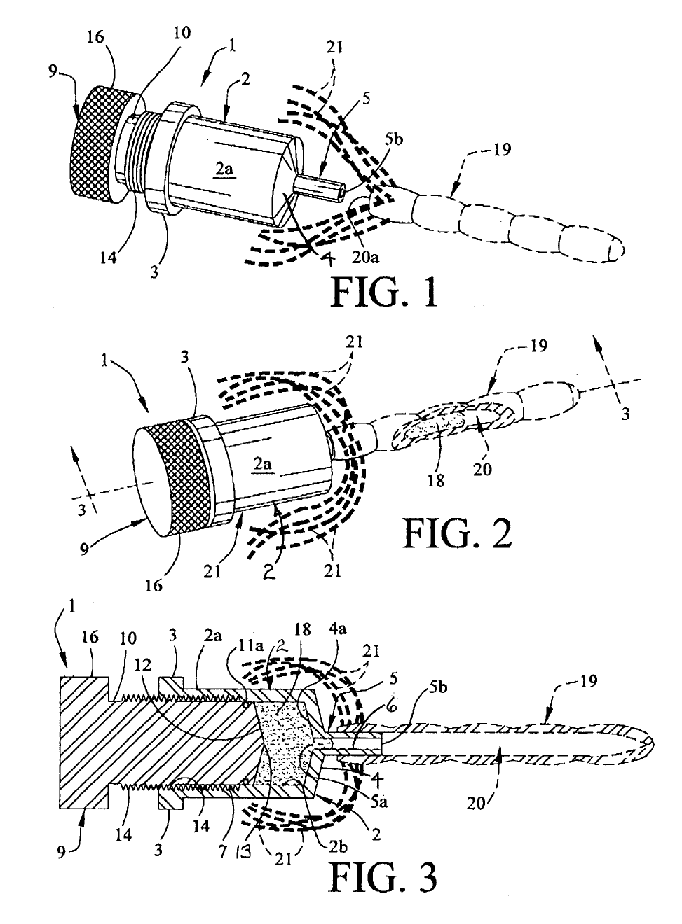

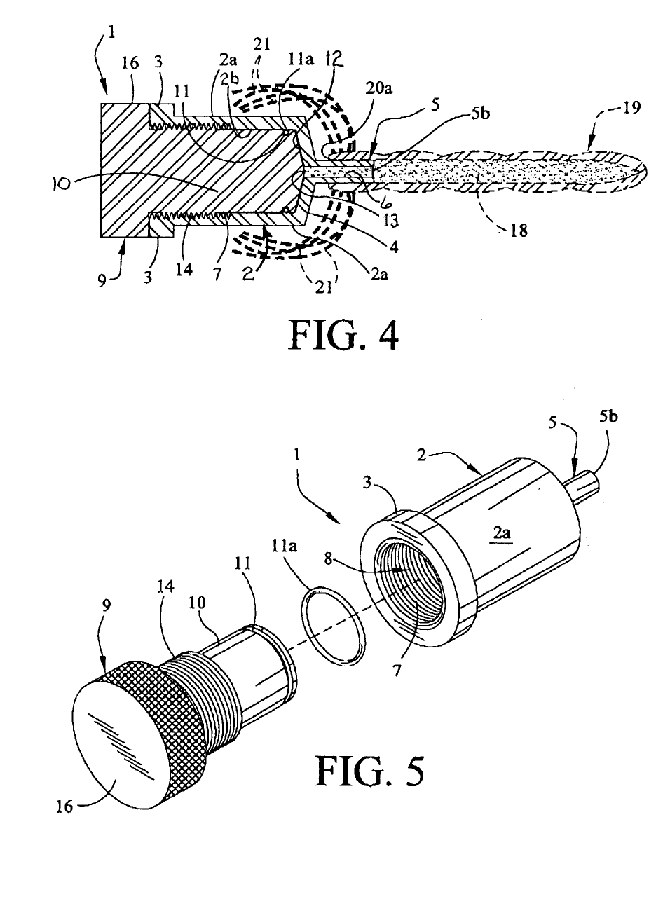

Referring to FIGS. 1, 3 and 5 of the drawings in a preferred embodiment the nozzle of this invention is generally illustrated by reference numeral 1. The nozzle 1 is characterized by a typically acrylic plastic nozzle cylinder 2 of selected diameter and length, having a cylinder flange 3 on one end and a cylinder shoulder 4 on the opposite end, which cylinder shoulder 4 tapers to define a spout 5 of selected length and diameter. The spout 5 has a spout bore 6 which communicates with a cylinder bore 8 (FIG. 5) defined by a cylinder inside wall 2b, which is smooth except for internal cylinder inside wall threads 7, as illustrated in FIGS. 3 and 4. The cylinder outside wall 2a is also typically smooth, tapers at the front to define the cylinder shoulder 4 and extends at the rear to define the cylinder flange 3. A shoulder inside surface 4a extends the cylinder inside wall 2b in the interior of the nozzle cylinder 2 and terminates in the center at a spout feed opening 5a, that defines the opening of the spout bore 6 in the spout 5. A spout dispensing opening 5b is provided in the extending end of the spout 5, as further illustrated in FIGS. 1 and 3.

As illustrated in FIGS. 1 and 3, a plunger 9 is characterized by a plunger cylinder 10 having a diameter slightly smaller than the cylinder inside wall 2b of the nozzle cylinder 2 and further provided with plunger cylinder threads 14, extending along a portion of the smooth plunger cylinder wall 15, as illustrated. A typically knurled plunger flange 16 is provided on one end of the plunger 9 and the opposite end of the plunger 9 is fitted with an O-ring seat 11 that accommodates an O-ring 11a, to seal the plunger 9 when the plunger 9 is threaded inside the nozzle cylinder 2, as illustrated in FIG. 4. Forwardly of the O-ring seat 11 the plunger cylinder 10 tapers at a plunger cylinder taper 12 to define a taper point 13 and match the taper of the shoulder inside surface 4a of the nozzle cylinder 2, when the plunger 9 is fully threaded and advanced into the nozzle cylinder 5 as further illustrated in FIG. 4.

It will be appreciated from a consideration of FIG. 3 that the plunger 9 can be inserted inside the nozzle cylinder 2 with the external plunger cylinder threads 14 threadably engaging the internal cylinder inside wall threads 7 and the O-ring 11 a seated against the smooth portion of the cylinder inside wall 2b, as illustrated. An attractant paste 18 of selected character, composition and viscosity, including live bait such as shrimp, is pre-positioned or loaded inside the cylinder bore 8 before the plunger 9 is inserted, to facilitate threading of the plunger 9 in the nozzle cylinder 2 by grasping the knurled plunger flange 16, rotating the plunger 9 with respect to the nozzle cylinder 2 and contacting the attractant paste 18 with the plunger cylinder taper 12 and the taper point 13. The spout dispensing opening 5b of the spout 5 is then projected into the conventional lure cavity 20 at the lure tail 21 end of the tubular soft plastic lure 19 (illustrated in phantom) as illustrated in FIG. 3. Additional rotation of the plunger 9 with respect to the nozzle cylinder 2 forces the attractant paste 18 through the spout feed opening 5a and the spout bore 6, to the dispensing opening 5b in the spout 5 and from the dispensing opening 5b into the lure cavity 20 of the tubular soft plastic lure 19, as further illustrated in FIGS. 2 and 4 of the drawings.

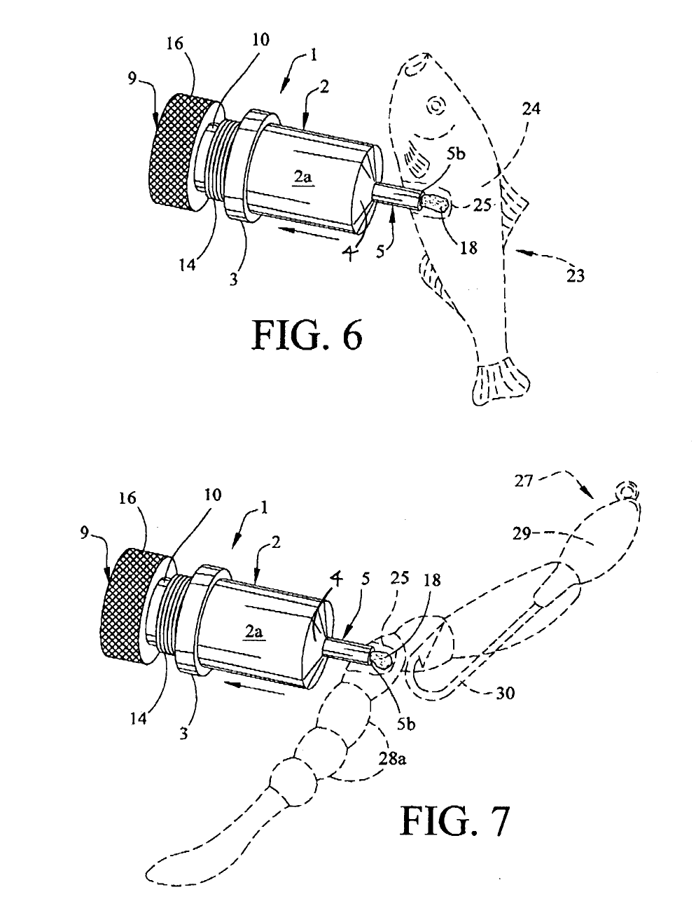

Referring now to FIG. 6 of the drawings in another preferred embodiment of the invention the nozzle 1 can be used to impregnate a solid soft plastic minnow lure 23 (illustrated in phantom), which has no body cavity but is constructed of soft plastic material, with the attractant paste 18, by insertion of the spout 5 into the soft minnow lure body 24 to create a spout cavity 25. The plunger cylinder 10 is then rotated by grasping the typically knurled plunger flange 16 and rotating the plunger flange 16 with respect to the nozzle cylinder 2 to compress the attractant paste 18 inside the nozzle cylinder 2 and force the attractant paste 18 from the spout dispensing opening 5b in the spout 5, into the spout cavity 25, as the spout 5 is slowly removed from the spout cavity 25, as indicated by the arrow in FIG. 6. This procedure facilitates retention of a quantity of the attractant paste 18 inside the spout cavity 25 in the minnow lure body 24 and, like the embodiments illustrated in FIGS. 1-5 of the drawings, facilitates exuding of small particles of the attractant paste 18 into the water as the minnow lure 23 is rigged in any desired manner and retrieved through the waterbody, to attract fish.

As illustrated in FIG. 7 of the drawings, a solid soft plastic worm lure 27 (illustrated in phantom) has a worm lure body 28, typically constructed with discreet body segments 28a, and a jig head 29 may be provided with a hook 30 for insertion in the worm lure body 28 for retrieval purposes. As in the case of the solid soft plastic minnow lure 23 illustrated in FIG. 6, the solid soft plastic worm lure 27 can be impregnated with a quantity of the attractant paste 18 by insertion of the spout 5 into a selected one of the body segments 28a to create an opening or spout cavity 25, in which the attractant paste 18 may be dispensed by rotation of the plunger cylinder 10 with respect to the nozzle cylinder 2, as described above. As the attractant paste 18 is dispensed from the spout dispensing opening 5b of the spout 5, the spout 5 is slowly withdrawn from the spout cavity 25 to retain a quantity of the attractant paste 18 therein, which attractant paste 18 will be exuded into the surrounding water as the solid soft plastic worm lure 27 is retrieved in conventional fashion.

It will be further understood by a consideration of FIGS. 1-7 of the drawings that the attractant paste 18 may be periodically replenished in the lure cavity 20 of the tubular lure 19, as well as in the respective spout cavity 25 of the solid soft plastic minnow lure 23 and the solid soft plastic worm lure 27, described above. Accordingly, fresh fish attractant 18 can be periodically added to these lures in order to replace the dispersed attractant and enhance the facility for catching fish when the respective lures are retrieved through a waterbody.

It will be appreciated from a consideration of the above description and the drawings that the nozzle of this invention can be used to inject a wide variety of viscous fish attractants such as the popular “Power Bait” and live bait, including shrimp, squid, fish and the like, in nonexclusive particular, in a carefully controlled manner into both tubular-type and solid soft plastic fishing lures of different shaped, design, plastic composition and size. Accordingly, the spout of the nozzle can be any selected size to fit the desired lure opening in the tubular soft plastic lures or to create a spout opening of desired size in the solid soft plastic lures. Furthermore, the flange 16 can be provided with a knurled finish, as desired and as illustrated in the drawings.

Accordingly, while the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A nozzle for injecting a fish attractant into a soft plastic fishing lure, comprising a nozzle cylinder having a spout for insertion in the soft plastic fishing lure and internal cylinder threads provided in said nozzle cylinder; and a plunger having external plunger threads for threadably engaging said internal cylinder threads and forcing the fish attractant from said nozzle cylinder through said spout and into the soft plastic fishing lure responsive to threadable rotation of said plunger in said nozzle cylinder and advancement of said plunger in said nozzle cylinder against the fish attractant.

2. The nozzle of claim 1 comprising at least one O-ring provided on said plunger in spaced-apart relationship with respect to said plunger threads for sealing the fish attractant in said nozzle cylinder between said O-ring and said spout.

3. The nozzle of claim 1 comprising a plunger flange provided on said plunger for gripping and rotating said plunger in said nozzle cylinder.

4. The nozzle of claim 3 comprising at least one O-ring provided on said plunger in spaced-apart relationship with respect to said plunger threads for sealing the fish attractant in said nozzle cylinder between said O-ring and said spout.

5. The nozzle of claim 1 comprising a cylinder flange provided on said nozzle cylinder for gripping said nozzle cylinder responsive to rotation of said plunger in said nozzle cylinder.

6. The nozzle of claim 5 comprising at least one O-ring provided on said plunger in spaced-apart relationship with respect to said plunger threads for sealing the fish attractant in said nozzle cylinder between said O-ring and said spout.

7. The nozzle of claim 1 comprising:
(a) a knurled plunger flange provided on said plunger for gripping and rotating said plunger in said nozzle cylinder; and
(b) a cylinder flange provided on said nozzle cylinder for gripping said nozzle cylinder responsive to said rotating said plunger in said nozzle cylinder.

8. The nozzle of claim 7 comprising at least one O-ring groove provided on said plunger in spaced-apart relationship with respect to said plunger threads and an O-ring seated in said O-ring groove, for sealing the fish attractant in said nozzle cylinder between said O-ring and said spout.

9. A nozzle for injecting a fish attractant material into a soft flexible plastic fishing lure, comprising a nozzle cylinder having a spout at one end for insertion in the soft flexible plastic fishing lure and internal cylinder threads provided in said nozzle cylinder; a plunger adapted for insertion in said nozzle cylinder; external plunger threads provided on said plunger for threadably engaging said internal cylinder threads in said nozzle cylinder when said plunger is inserted in said nozzle cylinder; an O-ring groove provided on said plunger and an O-ring seated in said O-ring groove for sealing the fish attractant material between said O-ring and said spout in said nozzle cylinder; and a grip provided on said plunger for gripping and rotating said plunger in said nozzle cylinder and advancing said plunger in said nozzle cylinder and forcing the fish attractant material from said nozzle cylinder through said spout and into the soft flexible plastic fishing lure.

10. The nozzle of claim 9 wherein said grip comprises a knurled plunger flange provided on said plunger.

11. The nozzle of claim 9 comprising a cylinder flange provided on said nozzle cylinder for gripping said nozzle cylinder responsive to said rotating said plunger in said nozzle cylinder.

12. The nozzle of claim 11 wherein said grip comprises a knurled plunger flange provided on said plunger.

13. A method for injecting a fish attractant material into a tubular soft plastic fishing lure, comprising the steps of providing a cylindrical housing having a smooth inside surface and internal housing threads provided in a portion of said inside surface and a spout for insertion in the tubular soft plastic fishing lure; placing the fish attractant material in the cylindrical housing; inserting an externally-threaded plunger in the cylindrical housing in threaded engagement with the internal housing threads; inserting the spout in the tubular soft plastic fishing lure; and threadably rotating the plunger with respect to the cylindrical housing to advance the plunger in the cylindrical housing against the fish attractant material and force the fish attractant material from the cylindrical housing, through the spout and into the tubular soft plastic fishing lure.

14. The method according to claim 13 comprising the step of providing an O-ring groove on the plunger and an O-ring seated in the O-ring groove, for sealing the fish attractant material in the cylindrical housing between the O-ring and the spout.

15. The method according to claim 13 comprising the step of providing a cylinder flange on said cylindrical housing for gripping said cylindrical housing.

16. The method according to claim 13 comprising the step of providing a plunger flange on said plunger for gripping said plunger.

17. The method according to claim 13 comprising the steps of:
(a) providing a cylinder flange on said cylindrical housing for gripping said cylindrical housing; and
(b) providing a plunger flange on said plunger for gripping said plunger.

18. A method for injecting a fish attractant material into a solid soft plastic fishing lure, comprising the steps of providing a cylindrical housing having an external cylinder flange, a smooth inside surface and internal housing threads provided in a portion of the inside surface, and a spout for insertion in the solid soft plastic fishing lure; placing the fish attractant material in the cylindrical housing; inserting a plunger having a plunger flange and external plunger threads in threaded engagement with the internal housing threads in said cylindrical housing; inserting the spout into the solid soft plastic fishing lure to create a nozzle opening; and threadably rotating the plunger with respect to the cylindrical housing to advance the plunger in the housing against the fish attractant material and force the fish attractant material from the cylindrical housing, through the spout and into the said solid soft plastic fishing lure as the spout is slowly removed from the nozzle opening.

19. The method according to claim 18 comprising the step of providing an O-ring groove on the plunger and an O-ring seated in the O-ring groove, for sealing the fish attractant material in the cylindrical housing between the O-ring and the spout.

20. The method according to claim 19 comprising a knurled finish provided on said plunger flange for gripping said plunger flange.
